(19) United States
(12) Patent Application Publication
(10) Pub. No.: US 2005/0152589 A1
(43) Pub. Date: Jul. 14, 2005

(54) CAD medical imaging system, components, and method of operation

(75) Inventors: Jeffrey C. Wehnes, Plano, TX (US); Eric A. Toncre, Friendswood, TX (US); Shelley Ahrens, Coppell, TX (US); Adam C. Hina, Allen, TX (US); Brant Lewis, Austin, TX (US)

Correspondence Address: MARGER JOHNSON & MCCOLLOM, P.C., 1030 SW MORRISON STREET, PORTLAND, OR, 97205, US

(73) Assignee: VuComp, Inc., Plano, TX (US)

(21) Appl. No.: 10/996,595

(22) Filed: Nov. 23, 2004

Related U.S. Application Data
(60) Provisional application No. 60/525,228, filed on Nov. 24, 2003.

(51) Int. Cl. G06K 9/00

(52) U.S. Cl. 382/128

(57) ABSTRACT

A system and method for electronically displaying CAD results are disclosed. In one exemplary embodiment, a flat panel display is attached to a film multi-viewer via an articulated arm that allows a radiologist to position the flat panel display with respect to the multi-viewer. A barcode scanner is mounted to the back of the display, allowing case identifiers on CAD hardcopy printouts to be read in order to indicate which results are to be viewed. A small embedded computer is mounted with or near the flat panel display and the barcode scanner, and retrieves CAD results from a remote CAD server when a case identifier is read by the barcode scanner. Other embodiments are described and claimed.

### RELATED CASES

This case claims priority to and incorporates by reference copending U.S. Provisional Patent Application 60/525,228, filed Nov. 24, 2003.

### FIELD OF THE INVENTION

The present invention pertains generally to Computer-Aided Detection (CAD) of features on medical imagery, and more particularly to systems, system components, and methods for use in CAD mammography.

### BACKGROUND OF THE INVENTION

CAD mammography systems have existed now for more than a decade. Such systems digitize traditional film mammograms, and then use computer algorithms to locate suspicious regions in one view, several views, or a time-series of mammograms. Additionally, some imaging systems now directly produce digital mammogram data and thus can be integrated with embedded CAD algorithms without digitization of film output.

A radiologist uses a CAD system by first viewing a set of mammogram films (or digital equivalent), and then checking the CAD results for the same set of films on a computer monitor. The computer monitor in a film-based system shows lower-resolution images of the films, with marks superimposed to show suspicious regions located by the CAD algorithms. If the radiologist has noted nothing suspicious in the films, but the CAD system identifies a suspicious region, the radiologist may re-evaluate the identified region on the films. Obviously, the more effective the CAD algorithms are at identifying real trouble regions without falsely identifying normal tissue, the more weight the radiologist will give to the CAD results. Also important, however, is the ease of use of the system, both for radiology technicians and for radiologists, so that the system provides a real benefit without unduly increasing workload.

Many radiologists view a large number of cases at a single sitting on a motorized film “multi-viewer,” which can be loaded with films for tens, or sometimes even hundreds, of cases. The radiologist manipulates controls on the multi-viewer to advance films and thus efficiently process a batch of cases.

Commercial CAD systems generally locate a computer monitor near a film viewer, where the radiologist can view both comfortably. Commercial CAD systems locate and display CAD results for a set of films in several ways.

Some CAD systems locate a keyboard on the multi-viewer to allow a radiologist to retrieve CAD results by entering a patient name or other identifier, where a technician has previously entered that information in the system.

Some CAD systems require that a unique barcode sticker be affixed to the films. Some systems simply use a barcode sticker peeled from a roll of unique stickers and affixed to the films prior to scanning, and read the barcode during film scanning. Other systems generate and print out a barcode when a case is scanned, and the technician affixes the barcode after scanning but before the films are transferred to a multi-viewer. After scanning and after the barcode is affixed, the radiologist uses a barcode wand or gun to read the sticker and cause the CAD system to display CAD results for that case.

Finally, some CAD systems are directly integrated with a multi-viewer, so that a radiologist can advance to the next film and advance to the next set of CAD results simultaneously. The latter systems require that a technician load cases to a scanner with cardboard separators interspersed between the cases. The scanner scans a set of films, and then scans the cardboard separator and reads a barcode affixed to the cardboard. When the technician subsequently hangs films on a multi-viewer, he slides the cardboard separators through a barcode-reader slot on the side of the machine, which then loads the corresponding CAD results in the same order.

Another integrated CAD system is described in U.S. Pat. No. 5,748,173. This integrated system uses a camera, bar code reader, or magnetic decoder to read identification information for a film loaded on a viewer, once that film is presented to an operator. The identification information is used to locate CAD images and results associated with the presented film. The located CAD images and results are retrieved from a database and displayed on a computer monitor.

### BRIEF DESCRIPTION OF THE DRAWINGS

The detailed description of the embodiments is best understood when read in view of the attached Figures, wherein:

FIG. 1 shows a CAD system according to some embodiments of the invention;

FIG. 2 shows a functional block diagram of a CAD station embodiment useful in the CAD system of FIG. 1;

FIG. 3 shows components of a viewing station embodiment useful in the CAD system of FIG. 1;

FIG. 4 illustrates the configuration of the CAD station of FIG. 2 in a portable cart;

FIG. 5 shows the cart embodiment of FIG. 4 with film scanner and printer removed;

FIGS. 6A-6D show the lower enclosure of the cart, illustrating the rack mount for servers and UPS, both with and without the servers and UPS installed;

FIGS. 7A-7E depict a fully assembled cart from a variety of angles;

FIGS. 8, 9, and 10 show the viewing station of FIGS. 1 and 2 attached to a film multi-viewer;

FIG. 11 illustrates the appearance and outside configuration of an embedded computer useful in the viewing station embodiments;

FIG. 12 shows a block diagram of the major components and ports of an embedded computer embodiment;

FIG. 13 contains a process diagram embodiment showing how the CAD station responds to user and other events;

FIGS. 14 and 15 show the appearance of the CAD station touch screen display at two times during CAD film input and processing;

FIG. 16 contains a process diagram embodiment showing how the viewing station responds to user events in a Load Cases mode;

FIGS. 17-19 show representative printouts generated by the CAD system;

FIGS. 20-24 show the appearance of the viewing station display in response to various user events in Load Cases mode;

FIG. 25 contains a process diagram embodiment showing how the viewing station responds to user events in a View Cases mode;

FIGS. 26-32 show the appearance of the viewing station display in response to various user events in View Cases mode; and

FIGS. 33 and 34 show a second viewing station embodiment integrated with a film multi-viewer.

### DETAILED DESCRIPTION OF THE EMBODIMENTS

CAD System Overview

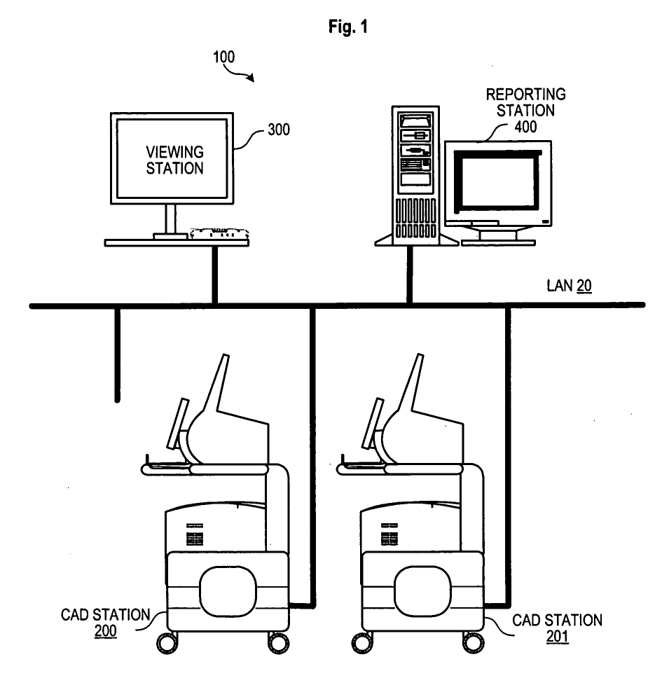

The present disclosure describes a CAD system, system components, and methods for operation. Referring to FIG. 1, one exemplary CAD system configuration 100 is shown. A CAD station 200 and a viewing station 300 are coupled to a Local Area Network (LAN) 20. A second CAD station 201 (optional) is likewise coupled to LAN 20, such that viewing station 300 can receive CAD results from either CAD station. Preferably, any number of viewing stations and CAD stations can be connected within such a network. A computer 400 (a workstation, desktop personal computer, etc.) can also communicate over LAN 20 with CAD stations and/or viewing stations, e.g., to monitor case status/workflow status for films processed by the CAD system.

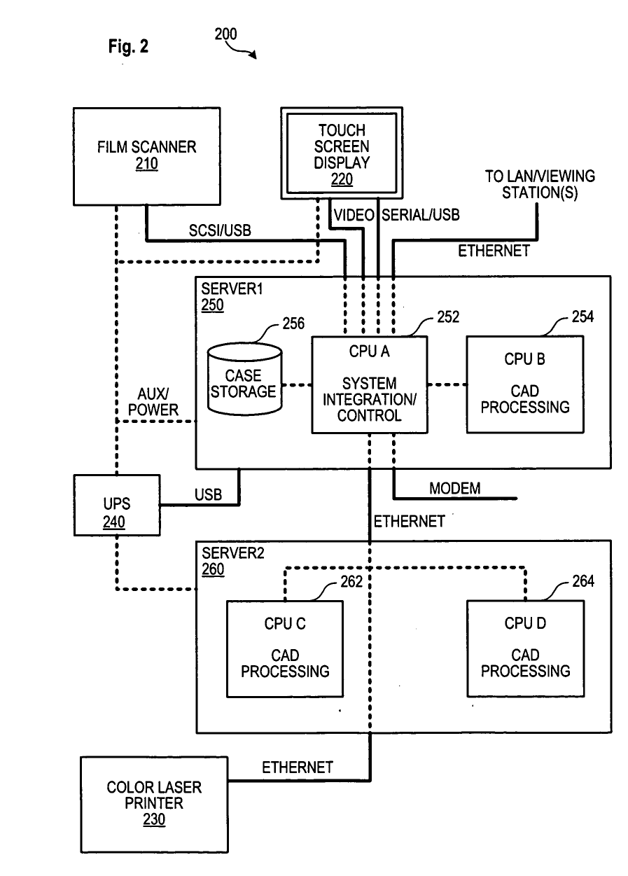

FIG. 2 shows a functional block diagram for some embodiments of CAD station 200. CAD station 200 contains components necessary to scan films into the CAD system, perform CAD processing, print results, and serve results to viewing stations. The major components of CAD station 200 are a film scanner 210, a touch screen display 220, a color laser printer 230, an Uninterruptible Power Supply (UPS) 240, and two servers 250 and 260. All of these components are integrated in a single compact cart, as will be described shortly.

Film scanner 210 provides a capability for high-resolution scanning of medical imaging films. Film scanner 210 may be, for instance a CAD Pro scanner available from Vidar Systems Corporation.

Touch screen display 220 provides an interactive interface for a technician. The technician manipulates a few simple buttons displayed on display 220 to start and stop the system, but has no more-detailed access to the system. Any commercial LCD touch screen display can be used for this task, for instance an ET1247L display available from Elo Touchsystems, Inc.

Color laser printer 230 is used to create case printouts, as will be described below. Although other types of printers (inkjet, black-and-white laser, etc.) can be substituted, a color laser printer is preferred to reduce cost/sheet and increase reliability, particularly for high-volume applications. Color is preferred in order to permanently and visibly record any marks found by the CAD algorithms. Any commercial color laser printer can be selected, for instance a C720 or C510 printer available from Lexmark International, Inc.

Server1 250 contains dual Central Processing Units (CPUs), CPU A 252 and CPU B 254, which are, e.g., Intel® Xeon® processors available from Intel Corporation, and a magnetic hard drive 256 to store case images and results. CPU A runs software to integrate and control overall system function, as will be described throughout this specification. Accordingly, CPU A: controls film scanner 210 through, e.g., a SCSI (Small Computer System Interface) or USB (Universal Serial Bus) port; interfaces with a technician through a touch screen display 220 connected to Server1 through a Video output and a serial or USB port; interfaces with color laser printer 230 over, e.g., an Ethernet connection; interfaces with viewing stations over an Ethernet connection; and interfaces with Server2 over an Ethernet connection. In some embodiments, each server is configured with only two Ethernet ports, and thus color laser printer 230 connects to the second Ethernet port on Server2, and CPU A spools print jobs to color laser printer 230 through its Ethernet connection to Server2. Alternately, any or all of the Ethernet devices in station 200 could connect directly to a LAN instead of to each other. Dedicated connections are preferred, however, as this allows the CAD system to function whether an external LAN is available or not. Server1 preferably has other ports, such as keyboard and mouse ports, that remain unconnected during normal system operation but are available for use during system configuration and/or maintenance. A modem port is also provided, and a modem optionally can be installed on CAD station 200, e.g., as a backup or alternative to an external LAN connection. Maintenance can also preferably be performed remotely through an Ethernet port.

CPU B is used for CAD processing, i.e., it processes cases assigned to it by CPU A and then notifies CPU A when results are available.

Server2 260 is optional, but increases system performance by providing third and fourth CPUs (CPU C 262 and CPU D 264) to process cases concurrently with CPU B. Like with CPU B, CPUs C and D are assigned cases by CPU A and return results to CPU A. Server2 may contain identical hardware to Server1, which provides redundancy and simplifies maintenance. Minor variations, such as no hard disk or a different size hard disk, may be incorporated as well. When a hard disk is part of Server2, Server2 can also export the disk or a partition of the disk (using, e.g., NFS (Networked File System) or CIFS (Common Integrated File System) software) to Server1 for additional case storage. As yet another alternative or supplement, Server2 and/or Server1 can mount a remote disk available to CAD station 200 over its external Ethernet connection.

UPS 240 supplies battery power to film scanner 210, touch screen 220, Server1, and Server2 in the event of power interruption. UPS 240 notifies Server1 through a USB connection when power is interrupted, and Server1 notifies Server2. Server1 finishes scanning any case that is currently being scanned by film scanner 210, waits for CPUs B, C, and D to complete any cases currently being processed or requests that the cases be suspended, displays a message on the touch screen stating that main power has been lost, and then initiates an orderly shutdown if the power interruption has not been resolved. This allows the system to reach an orderly stopping point that will not leave a technician confused as to what has and has not been processed, and should not result in a missing case.

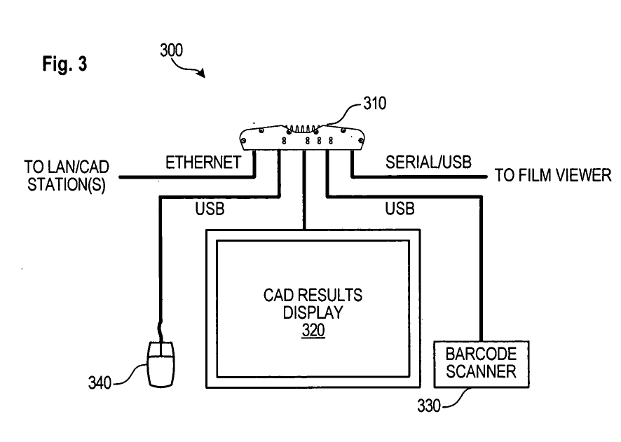

Viewing station 300 provides the remaining functionality for CAD system 100. A typical viewing station 300 is illustrated in FIG. 3. An embedded computer 310 provides viewing functionality through five ports. An Ethernet port allows embedded computer 310 to communicate with CAD stations to retrieve case results for display. A video output port sends viewable CAD results to a CAD results display. Two input device ports, e.g., USB or serial ports, provide connections for a barcode scanner 330 and a mouse 340 or other input device. Another USB or serial port can provide an optional connection to a motorized film viewer, allowing synchronized navigation between CAD results panels and corresponding multi-viewer film panels.

The embedded computer can be a custom standalone unit, as will be described in one embodiment. In other embodiments, the display and embedded computer can be integrated into the display case. For instance, an Apple iMac G5 can be adapted to provide the viewing station functions, as will be described in more detail below.

With the preceding general system overview as background, a more detailed description of various features and components of CAD system 100 will now be undertaken. The CAD station general design, view station general design, and the case scanning/processing function, case loading function, and case viewing function will each be described in turn.

CAD Station Hardware

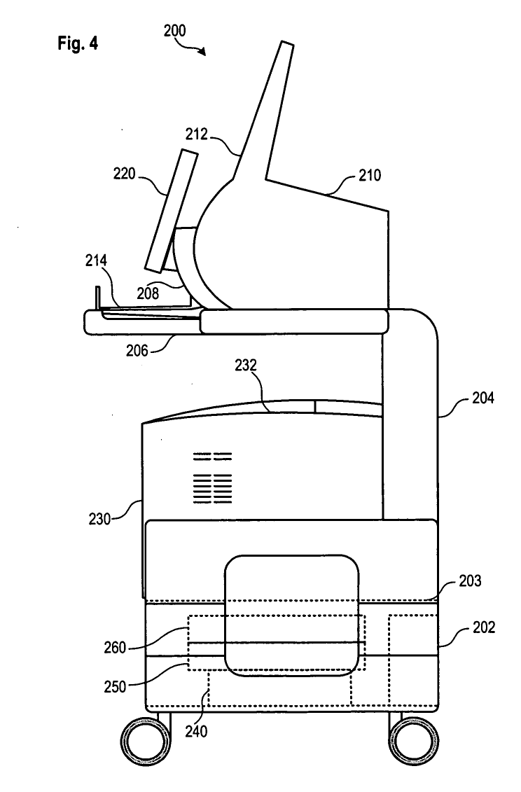

FIG. 4 shows a side view of a CAD station 200 embodiment configured as a wheeled cart. The cart comprises a lower enclosure 202, shelf struts 204 (one visible), and a cantilevered shelf 206. Cantilevered shelf 206 includes a mounting bracket 208 for touch screen display 220. The cart can be moved as necessary, and then operated by connecting a single external power cable. When results from the CAD station are desired, the cart must be located where an Ethernet jack (or other suitable LAN connection or modem connection) is available (if desired, however, a wireless LAN transceiver could be used for LAN connection, removing the Ethernet jack limitation).

Lower enclosure 202 houses UPS 240, servers 250 and 260, and in some embodiments a modem (not shown). The top of enclosure 202 forms a shelf 203, upon which color laser printer 230 rests. This design places the heavy UPS at the bottom of the cart, and places the printer low on the cart, thus lowering the center of gravity of the cart and increasing stability. Further, since radiology technicians will seldom if ever need access to the servers, UPS, and fan tray, these components are located out of the way so that easy access can be provided to the components that the technician will access.

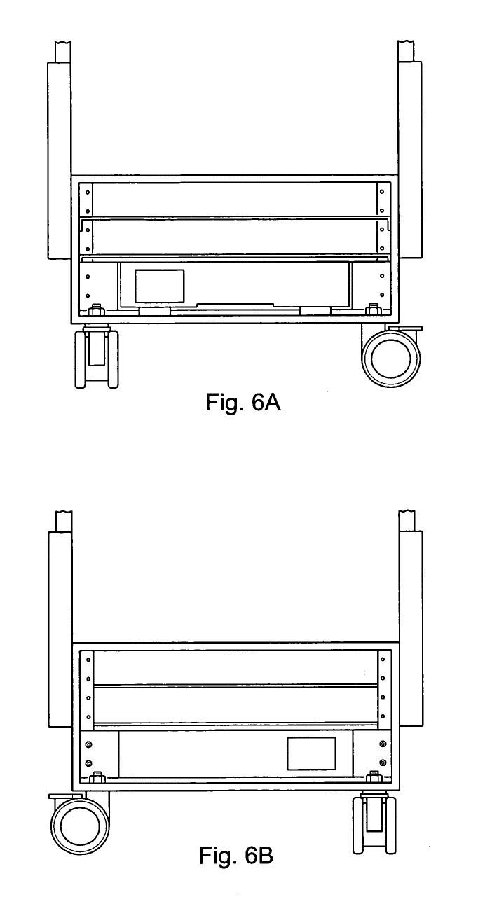

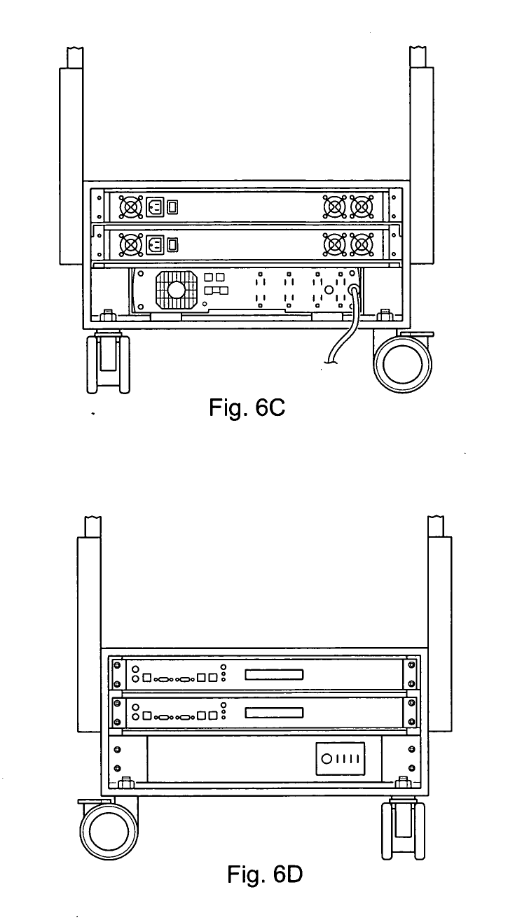

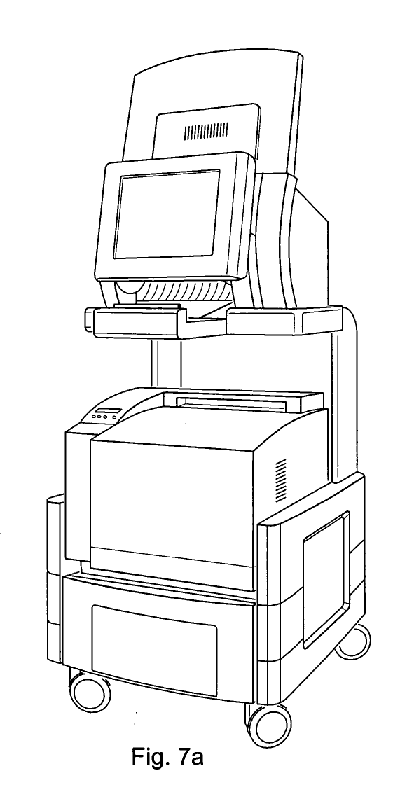

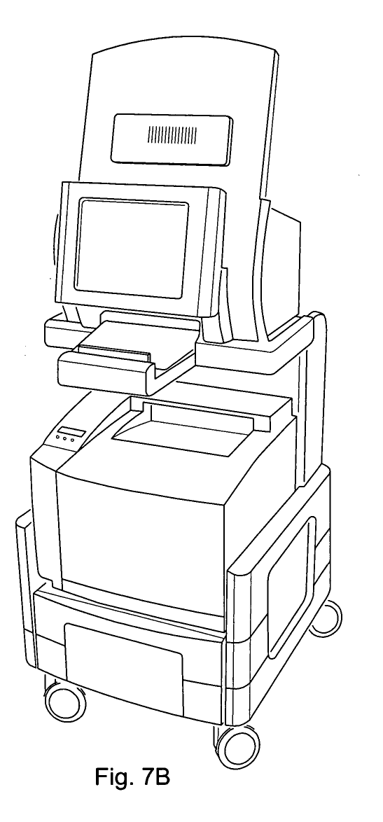

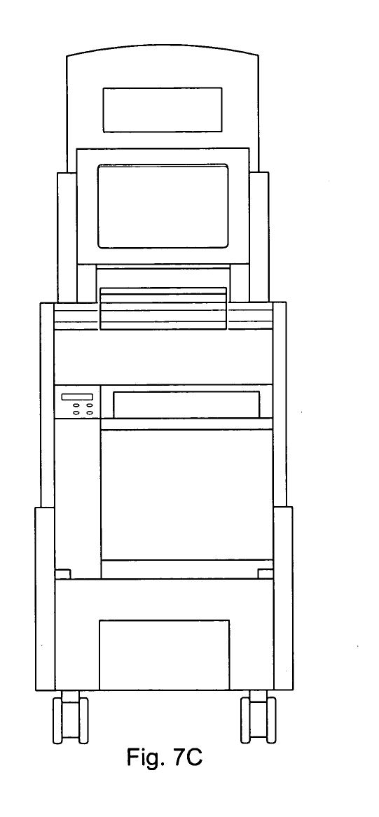

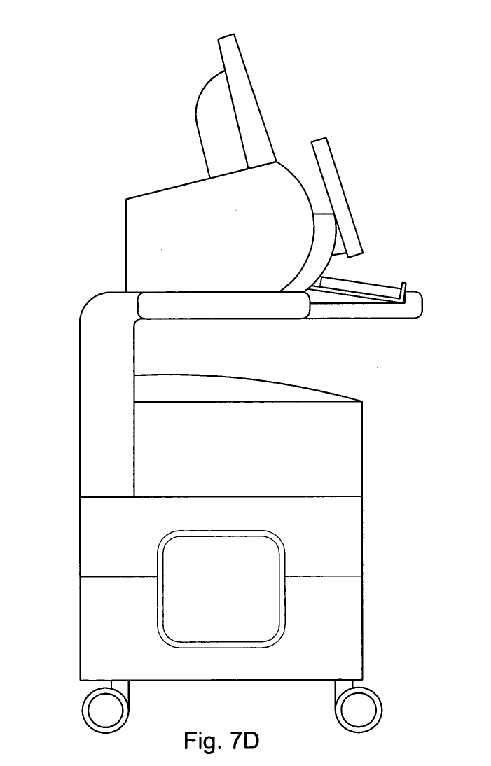

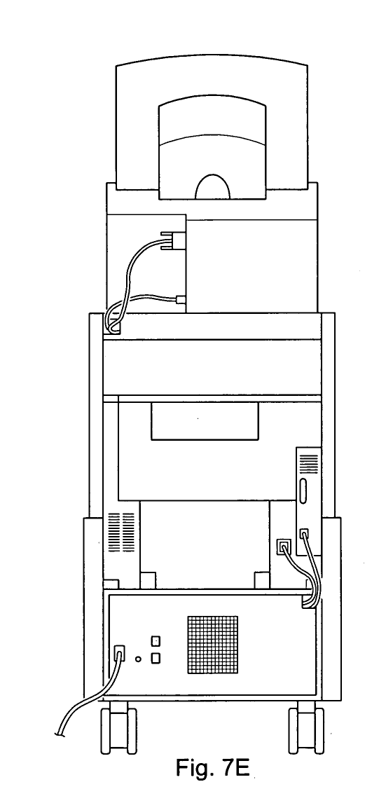

Another benefit of this design is that the mechanical noise generated by the system cooling fans is attenuated at walking level. Air enters the lower enclosure through slots in the bottom of the enclosure along the front and one side of the enclosure floor (see FIG. 6C), and exits the lower enclosure through a grill located on the back of the lower enclosure (see FIG. 7E). This directs much of the fan noise towards the floor or back wall. Additionally, the sides and/or back of lower enclosure 202 can be fitted with sound insulation to further decrease noise.

The lower enclosure also provides rack space, so that rack-mounted servers and a rack-mounted UPS can be used (see FIG. 6A, front of rack; FIG. 6B, rear of rack; FIG. 6C, front of rack with UPS, Server1, and Server2 in place; and FIG. 6D, rear of rack with UPS, Server1, and Server2 in place). This rigidly attaches the components in a minimal amount of space, which diminishes the size and weight of the cart. Also, having the UPS mounted in the cart ensures that connections to the system components are properly maintained.

Lower enclosure 202 also provides a secure shelf for laser printer 230. The sides of the lower enclosure extend up along the sides of the printer shelf 203 to prevent the laser printer form shifting off the sides of the cart. The front and rear of the shelf are left open to allow access to paper trays and other replenishable-printer-supply doors.

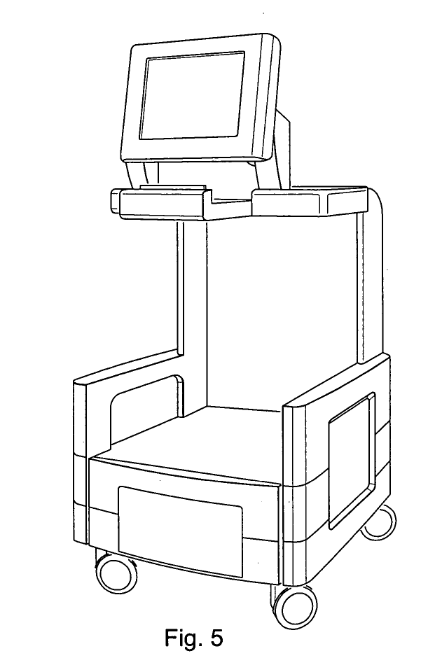

FIG. 5 shows a front three-quarters view of the cart with the film scanner and printer removed for visibility. Shelf struts 204 are positioned at the rear of the cart, and upper shelf 206 is cantilevered forward from struts 204. This provides easy access to the top of printer 230 from three sides. The shelf struts, as well as the other major structural components of the cart, are constructed of aluminum.

Shelf 206 provides a support for film scanner 210. The footprint of shelf 206 approximates the footprint of the film scanner, so that a technician has easy access to the film loading slot 212 and the film discharge slot 214 of scanner 210. Additionally, the close proximity of film discharge slot 214 to printout discharge slot 232 of printer 230 makes it easy for a technician to gather scanned films and CAD printouts for transfer to a viewing station.

Mounting bracket 208 attaches to shelf 206. Preferably, the film scanner discharge slot 214 slides between the two sides of mounting bracket 208, thus positioning and mechanically constraining the scanner on the cart. Touchscreen display 220 mounts to the front of bracket 208, thus placing the display in an easily viewable position.

FIGS. 7A through 7E show a fully assembled CAD station from a variety of viewing angles from which one can appreciate the compact and ergonomic design of the station, as well as the other features of the station design.

Viewing Station Hardware

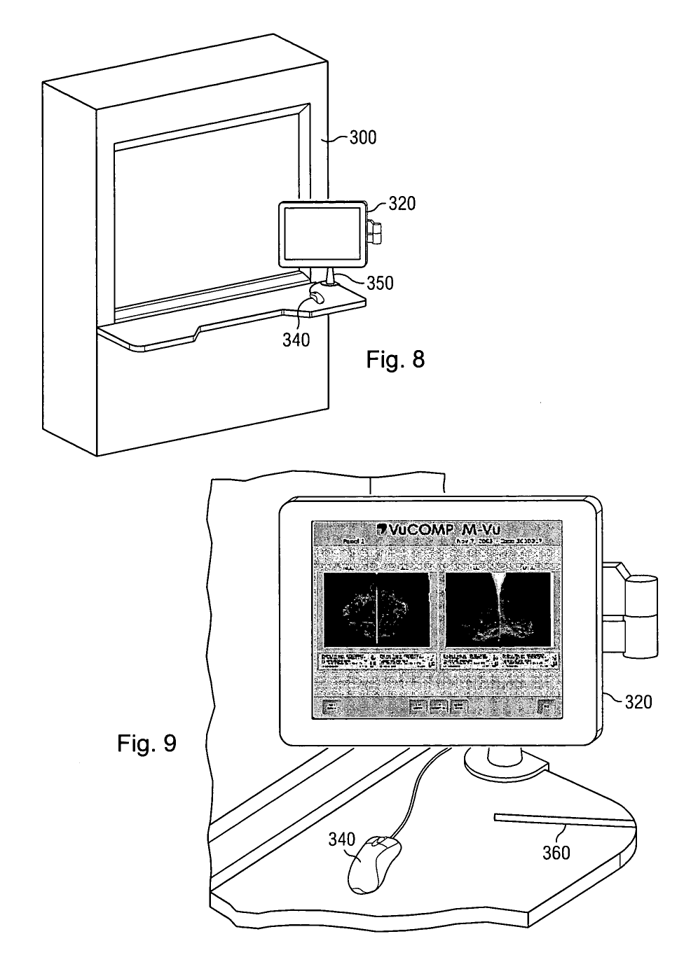

The viewing station is designed for mounting on or near an existing film viewer, although the components could be integrated into a new film viewer and provided as a package. FIGS. 8-10 show a typical installation on a multi-viewer for one embodiment. In recognition that space is often limited on and around such multi-viewers, the described embodiment is designed to impact that space as little as possible.

Referring to FIGS. 8 and 9, the only viewing station components visible to the radiologist are a CAD results display 320 and mouse 340. Display 320 attaches to a mounting arm 350, which leaves most of the radiologist's workspace free by placing the display above the space. Mounting arm 350 also allows the radiologist to place the display at a comfortable height, angle, and position for viewing.

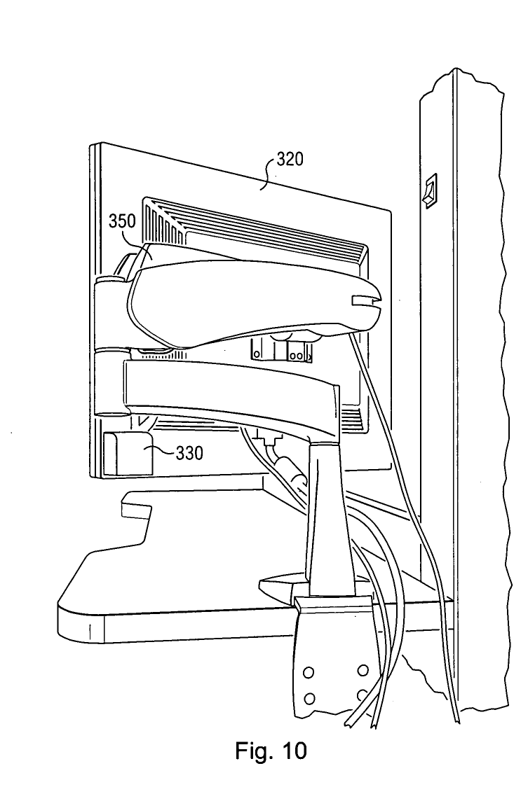

Also visible on the tabletop in FIG. 9 is scattering 360 from a laser beam emitted from an activated barcode scanner 330. Scanner 330 is not visible in FIG. 9 because it is mounted to the backside of display 320. FIG. 10 shows the backside of display 320, and clearly shows the position of barcode scanner 330 and mounting arm 350. The barcode scanner can be positioned on the opposite bottom corner of display 320 when the mounting arm is positioned in a left-handed position on the multi-viewer workspace, or can be positioned more centrally along the backside of display 320.

Embedded computer 310 is not shown in FIGS. 8-10 as it is designed to be mounted or placed in an out-of-the-way location, such as under the multi-viewer desk, beside the multi-viewer, on the backside of display 320, etc.

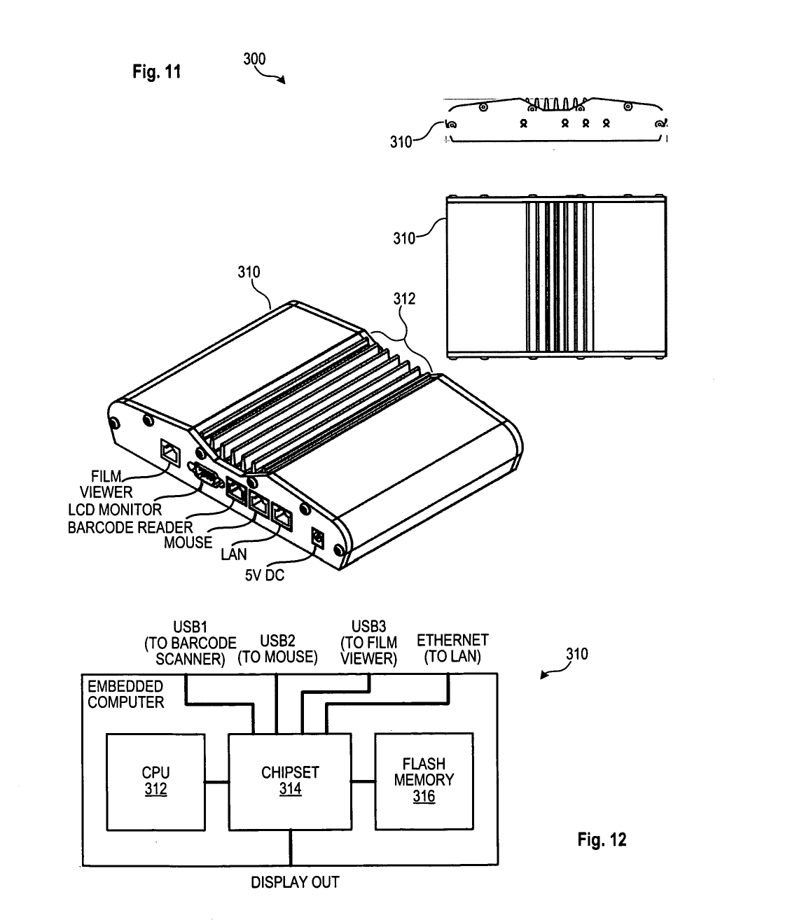

FIG. 11 shows front, top, and perspective views of one embodiment of embedded computer 310. FIG. 12 shows a corresponding block diagram of embedded computer 310. Computer 310 comprises a CPU 312 (e.g. an Intel® Pentium III with a supporting chipset 314 and 1 GB of attached flash memory 316. The chipset supports a display out port for an LCD monitor, an Ethernet port for attachment to a LAN, and three USB ports USB1, USB2, and USB3 for a barcode scanner, a mouse, and a film viewer interface. The CPU, chipset, and flash memory are mounted in a small metal enclosure, including cooling fins 320, that is designed to dissipate heat from the CPU and chipset without need for a fan. The lack of an internal fan and electromechanical disk drive allows for a very small package size and silent operation. The default storage capacity of flash memory 316 is sufficient to store results from about 160 typical cases, plus the executable code needed to operate the viewing station, but other sizes of flash memory can be selected.

The embedded computer could be replaced in some embodiments with a more traditional desktop or tower unit, although this would generally increase bulk, power consumption, and noise, and would make the system more susceptible to theft and damage.

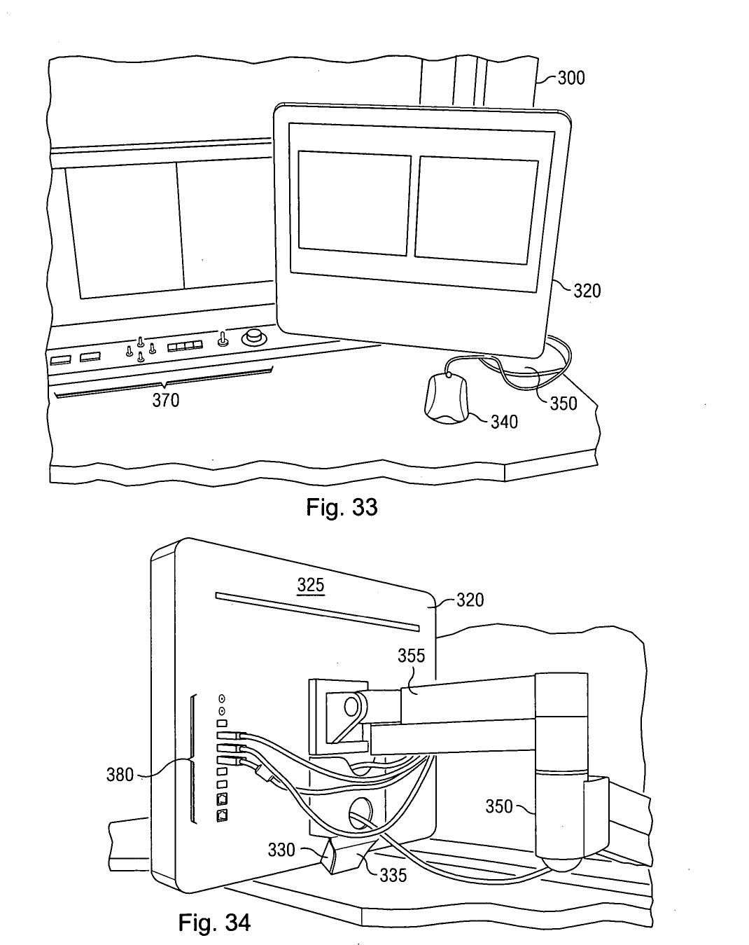

Another preferred viewing station embodiment is illustrated in FIGS. 33 and 34. FIG. 33 shows a commercially available multi-viewer 300, e.g., a Rolloscope, including its panel controls 370. Display 320 is a commercially available Apple iMac G5, which includes an embedded computer mounted behind the display. Display 320 has a 16:9 aspect ratio, which better matches the aspect ratio of a film multi-viewer than a traditional 4:3 aspect ratio display. Also shown in FIG. 33 are the mouse 340 for controlling the CAD viewing station and the mounting bracket for a display arm 350.

FIG. 34 shows the backside of display 320 and additional features of the embodiment. Display 320 is mounted in a case 325, along with the embedded computer. Although the embedded computer can be equipped with only solid state memory, in the illustrated embodiment an internal 80 Gb hard drive stores CAD viewing station software and currently loaded cases.

The various connections to the embedded computer are shown in a connector region 380 along one side of the back of case 325. Wires for the mouse, LAN, barcode reader, and film viewer interface are routed along a hollow enclosure 355 on the top of mounting arm 350 to corresponding connectors in connector region 380. Optionally, one or more of these connections can be replaced with a wireless interface, e.g., an IEEE 802.11g or Bluetooth interface.

Other structural features of the viewing station are also depicted in FIG. 34. A bracket at the end of mounting arm 350 attaches through case 325 to the metal chassis structure to provide secure mounting for the viewing station. Directly below the mounting arm attachment, a bar code reader enclosure 335 attaches to case 325. The bottom section of enclosure 335 is angled such that bar code reader 330 can project its scan line below and slightly forward of display 320.

CAD Station User Operation

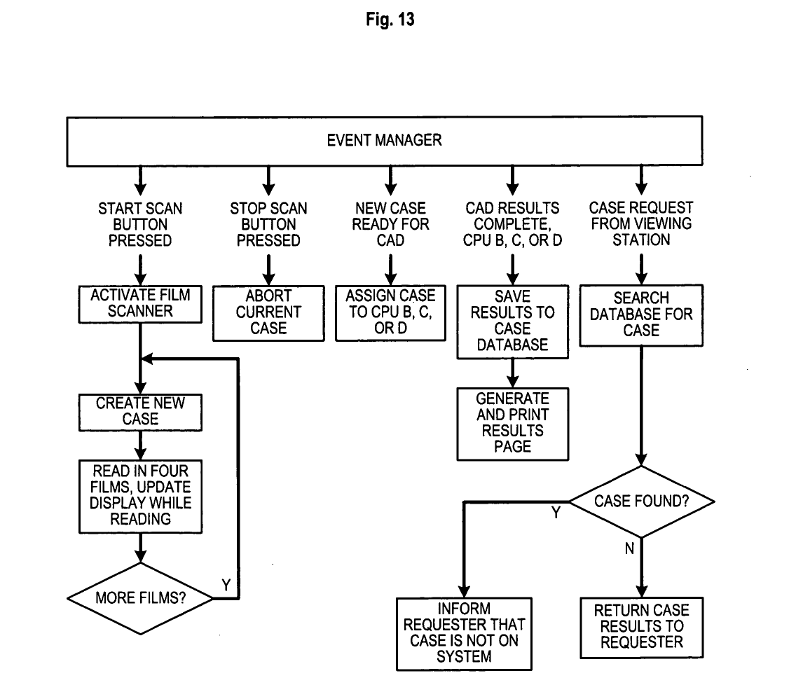

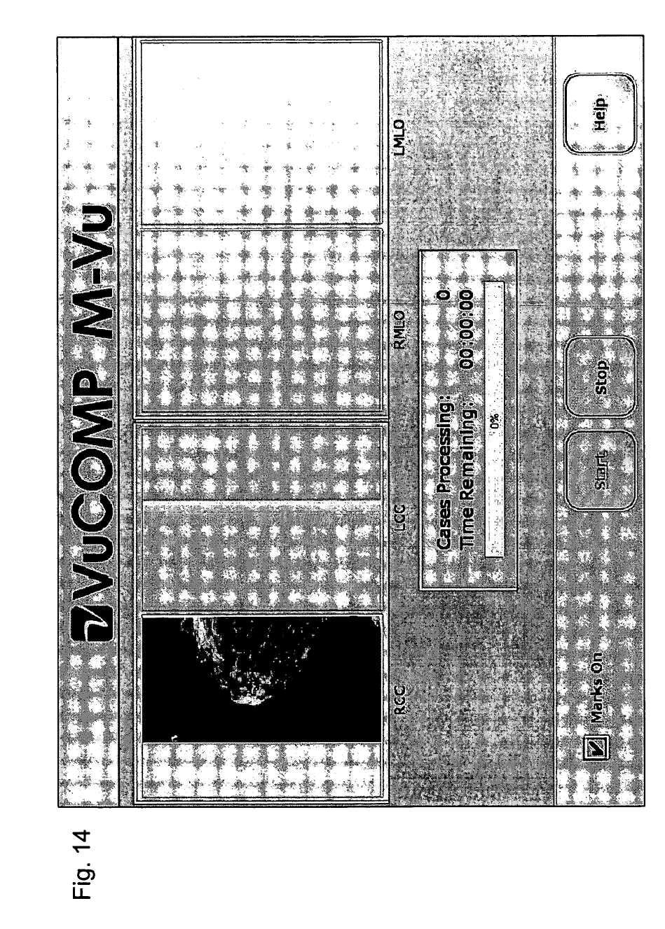

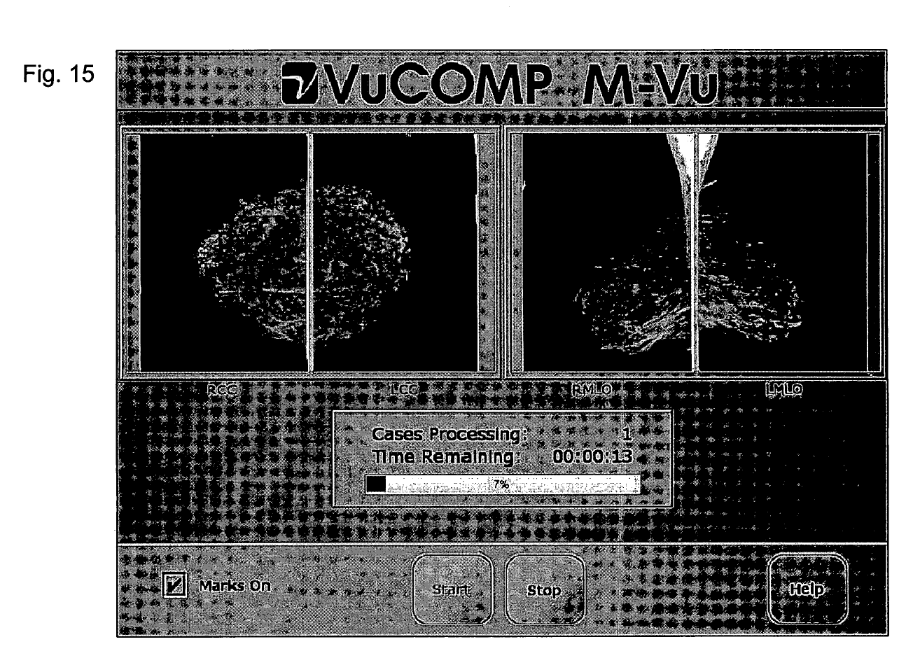

CAD station 200 preferably presents a simple user interface to a technician responsible for loading cases into the CAD system. FIG. 13 shows the basic “events” that Server1 responds to during case entry. FIGS. 14 and 15 show images from touch screen display 220 during film scanning and CAD processing, respectively.

Referring first to FIG. 14, the basic interface contains two user controls, a “Start” touch screen button and a “Stop” touch screen button. Two informational display areas are displayed in the center region of the touch screen. The first has four sub-regions that display up to four scanned films for the currently scanning case. As a particular film is being scanned, a white bar progresses across the sub-region corresponding to that film. For instance, in FIG. 14 the “LCC” film is currently being scanned, and the white bar shows approximately how much of the film remains to be scanned. Once the film is completely scanned, a reduced-size digitized version of the film is displayed in the corresponding sub-region (see the “RCC” region for an example). The technician can view the scans and detect mis-ordered, flipped, or inverted films, or other scanning problems from the display.

The second informational display informs the technician of CAD progress on the newly-scanned cases. In the example of FIG. 15, one case is being processed, is 7% finished, and has 13 seconds left to completion. With the “Marks On” option selected, marks will be displayed for the current case on the four small images when CAD processing is completed.

Returning to FIG. 13, the major events in a new CAD run are shown. When the “Start” touch screen button is pressed, Server1 activates the film scanner, creates a new case, and then reads in digitized film data for four films. The touch screen display is updated periodically to indicate scan progress. Note that in one embodiment, if an incomplete set of films is used the technician is expected to load a blank film into the scanner to replace each missing film in the set, such that a complete four-film set is still processed. During CAD processing, the blank films will be detected and not used to calculate CAD results.

After a four-film set has been successfully scanned, if the scanner detects additional films in its loading tray, Server1 loops back to create a new case and repeat the steps to enter digitized films for that case. Meanwhile, a “New Case Ready for CAD” event causes a process to determine one of CPUs B, C, or D to receive the first set of digitized films for CAD processing. The case is transferred to the appropriate CPU, and Server1 updates the “Cases Processing” region of the touch screen display periodically to indicate the progress of the CAD processing.

When the “Stop” button is pressed by a technician, the system aborts scanning of the current case, but continues CAD processing on any cases already entered into the system.

When CAD results for a case are available, Server1 saves the results to the case database. A results page is then generated and printed on the color laser printer. The ordering of the results pages on the printer is the same order as the films sets fed into the film scanner. This allows the technician to take the two stacks (films and printouts) to a viewing station for loading, or easily distribute films and results pages to case files.

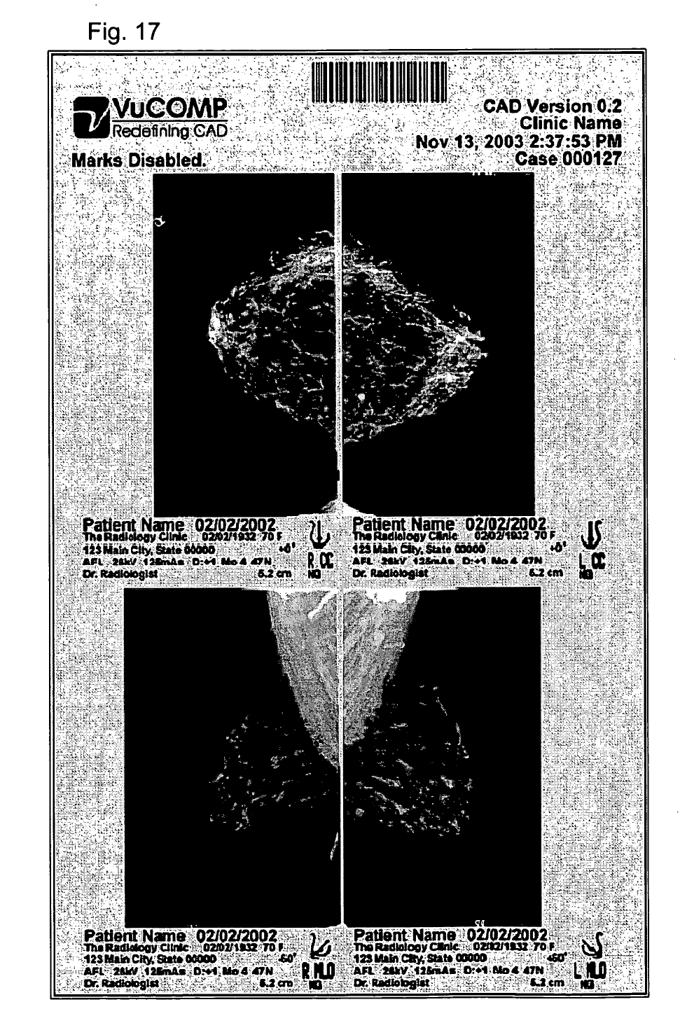

FIGS. 17-19 show sample results pages. Each has several useful features. For instance, the top of each results page contains a unique barcode generated for that case by Server1. The barcode quickly associates the results page with a results file for that case stored in Server1. The printout serves as a receipt that CAD has been performed on the displayed film set.

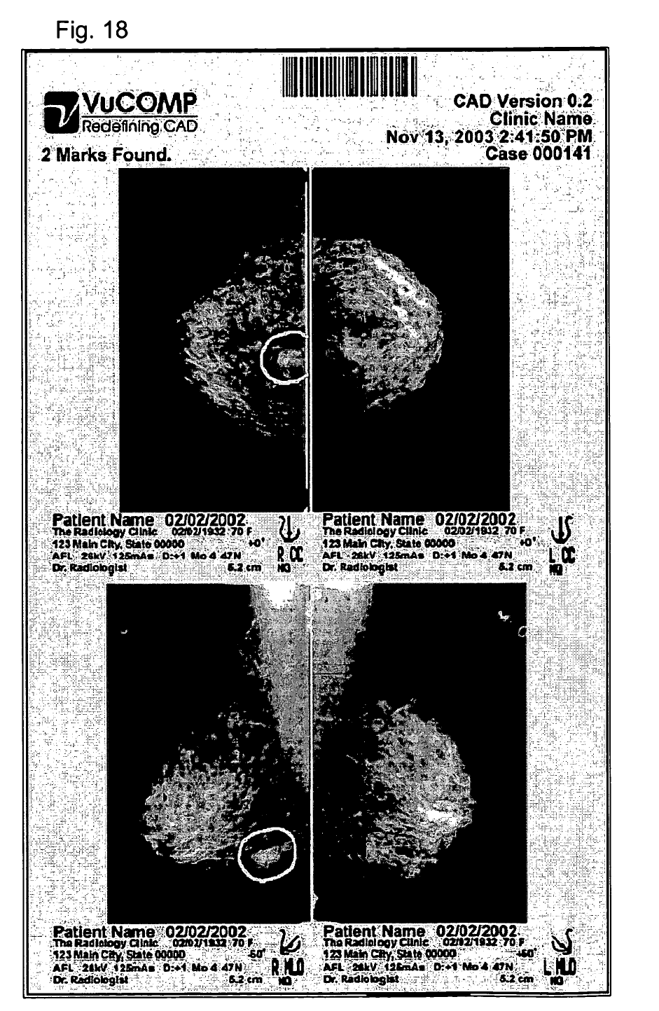

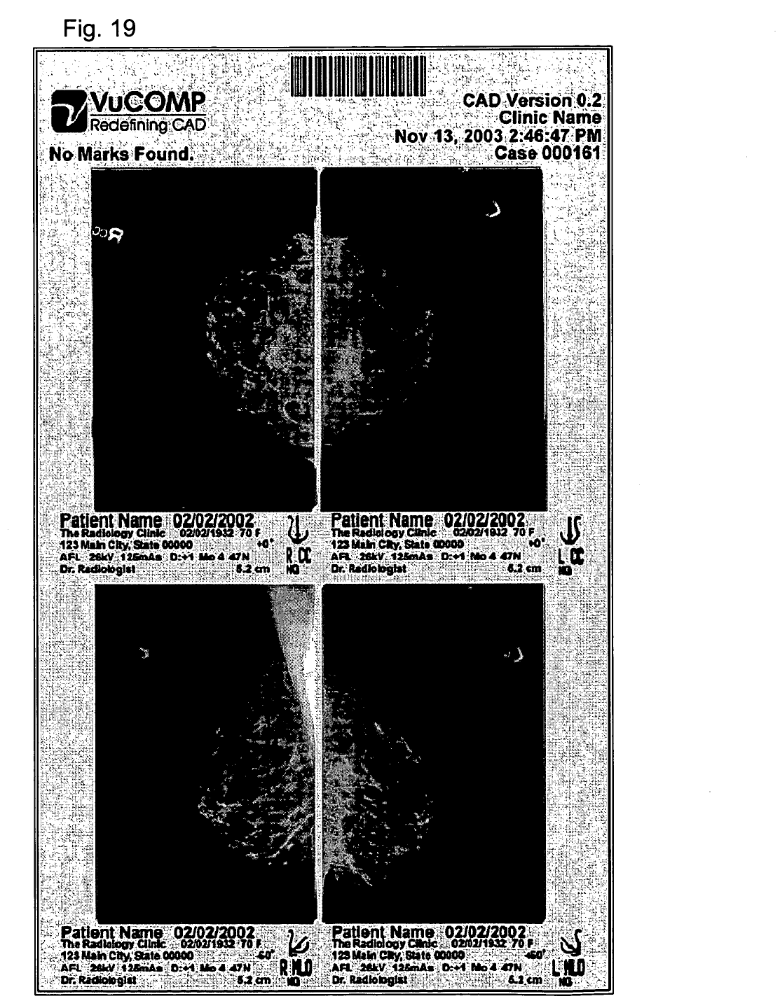

Below the barcode are left and right headers. The left header indicates whether the results page was generated with “Marks On” or “Marks Off.” For instance, in FIG. 17, the caption “Marks Disabled” indicates that this results page was generated without any indication of the CAD results for the case. In FIG. 18, the caption “2 Marks Found” indicates that the results page was generated with CAD results indicated. The two marks are indicated, respectively on the RCC and RMLO images printed on the results sheet. A solid red line surrounding a region (such as shown in FIG. 18) indicates a suspicious density. A dashed red line (not shown in FIG. 18) outlines a suspicious architectural distortion, and a dotted red line (also not shown in FIG. 18) outlines a calcification. In FIG. 19, the caption “No Marks Found” indicates that CAD processing found no suspicious regions in the film set. Also, should the CAD processing be unable to successfully process a case, an error message “ERROR PROCESSING CASE” can be printed on the results page.

The right header indicates the CAD software version used to process the film set, the clinic name, date and time of processing, and case number.

The printout is preferably of suitable quality that it can be placed in the file to verify that CAD was used on the film set and the results obtained. In addition to header and results, the printout shows printed versions of the four film scans, each having a corresponding label data extracted from that film placed directly below it. The label is extracted from each image during CAD processing. A technician or radiologist can verify from this data that the films were properly loaded and that each belongs to the same patient.

Returning briefly to FIG. 13, the last event indicated is a case request from a viewing station. When a viewing station reads a barcode from one of the printouts, it queries the CAD station for the case corresponding to that barcode. Server1 searches its case database for the case, and if found, returns displayable film images, displayable label images, and CAD results symbology to the viewing station.

Some embodiments are designed such that when the case storage database reaches a certain size, new cases begin to replace the oldest cases in the database. The oldest cases could simply be deleted, or moved to an off-system archive database. Also, when two or more CAD stations operate in the same clinic, the requested case may be valid but not stored on this CAD station. In all of these cases, the CAD station would respond to the viewing station that the requested case is not in the system.

Viewing Station Load Cases Mode

The viewing station has two basic modes of user operation, a “Load Cases” mode and a “View Cases” mode. The Load Cases mode will be explained first.

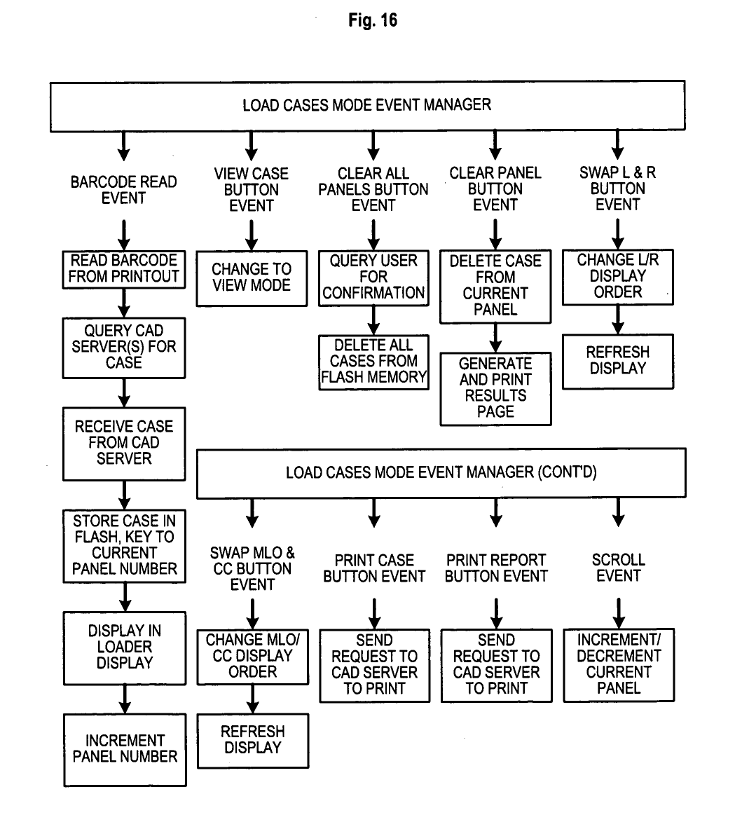

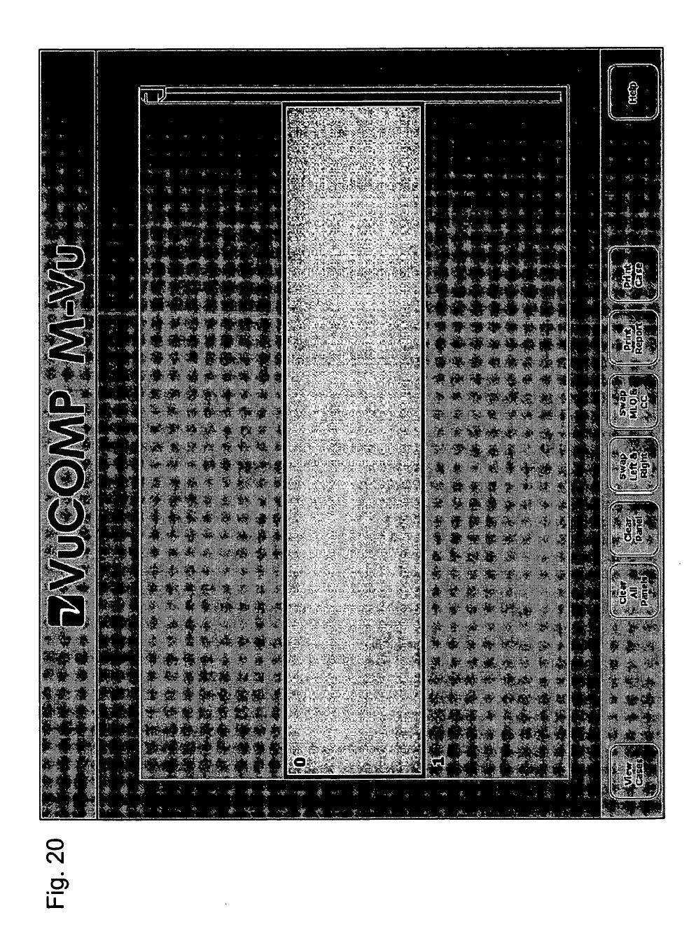

FIG. 16 shows the basic user events that can be initiated by a technician during case loading. FIGS. 20-24 illustrate the appearance of the viewing station display during or after certain of these events, and will be referred to as necessary.

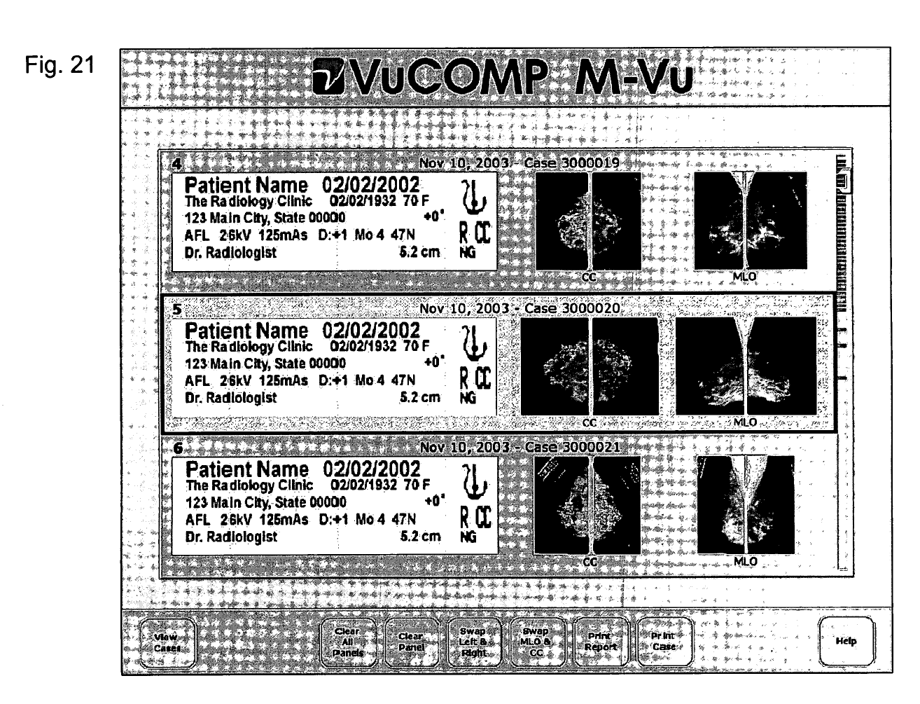

FIG. 20 shows the Load Cases screen when no cases are loaded into the viewing station, and FIG. 21 shows the same screen with cases loaded. A central region displays numbered “panels” corresponding to cases loaded in the system, and resembles the numbered panels of a film multi-viewer. A slider bar at the right of the central panel display can be manipulated to cause scroll events that change the three panels currently visible in the display. Note that the region under the slider bar provides a visual indication of which panels are currently loaded with case data (a dark bar indicates a loaded panel) and which are empty. The number of “bars” in the slider bar region is configurable to match the maximum number of panels that can be loaded. Normally, this maximum number of panels is set to match the number of panels in a film multi-viewer to which the viewing station is attached.

A row of buttons across the bottom of the display can be selected with a mouse to cause most of the other events in FIG. 16.

A user can step through the panels using scroll events, generate either by grabbing the slider bar with the mouse and sliding it, or by manipulating the mouse scroll wheel. As the panels are scrolled, the middle of the three visible panels becomes the active panel which is controlled using many of the buttons at the screen bottom.

In Load Cases mode, barcode scanner 330 is activated. One method of coordinating CAD results loading with loading of a film multi-viewer is to load the film set on a panel of the multi-viewer, and then run the corresponding CAD results sheet for that film set under the barcode laser scanner to cause a FIG. 16 barcode read event. The viewing station responds to the barcode read event by noting the barcode case number and then querying the CAD station for that case number. If more than one CAD station exists in the system, or some CAD results are stored on a separate file server, the viewing station may have to issue the request to multiple sources in order to locate the case. Once found, however, the viewing station receives the case from the CAD server and stores it in flash memory, keyed to the current panel number.

When the case has been loaded, the small panel display for the current panel (with a brighter border to indicate that it is the active panel) is updated with a date and case number, a patient label from a non-blank film, and a thumbnail for each of the four films stored in the case file. Finally, the current panel is incremented and scrolled to prepare the system for a next barcode read event. In some embodiments, when the current panel is incremented a message can also be sent to the controller of a coupled film multi-viewer, allowing the film multi-viewer to advance to a next panel as well.

A technician can use the buttons at the bottom of the display to further control loading options. The “Clear All Panels” button creates an event that first queries the user for confirmation, and upon confirmation removes all currently loaded cases, restoring the system display to that shown in FIG. 20. The “Clear Panel” button creates an event that removes any case data associated with the current panel (for instance panel 5 in FIG. 21), e.g., in the event of a loading sequence error.

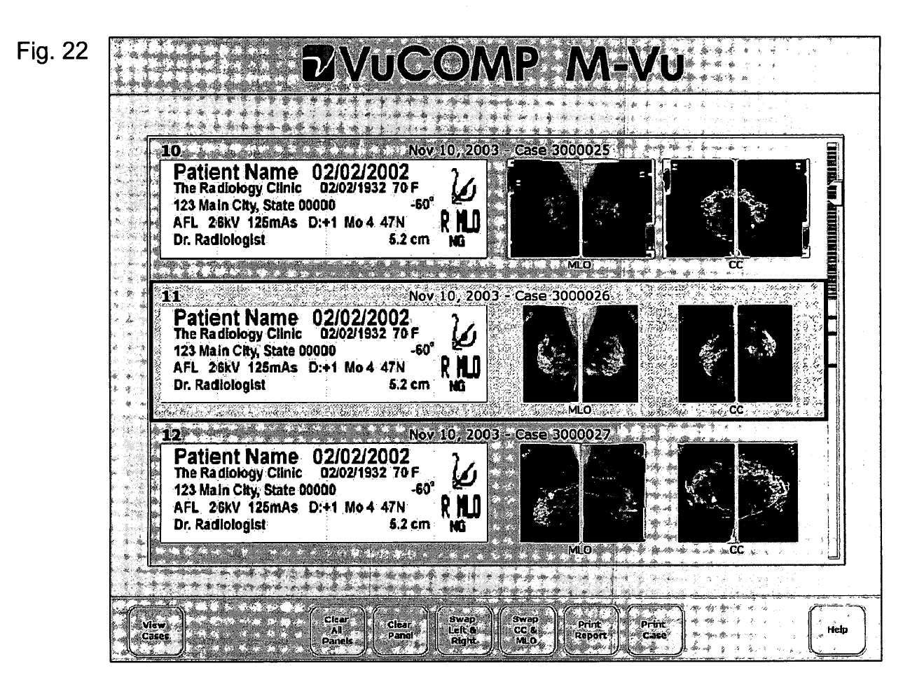

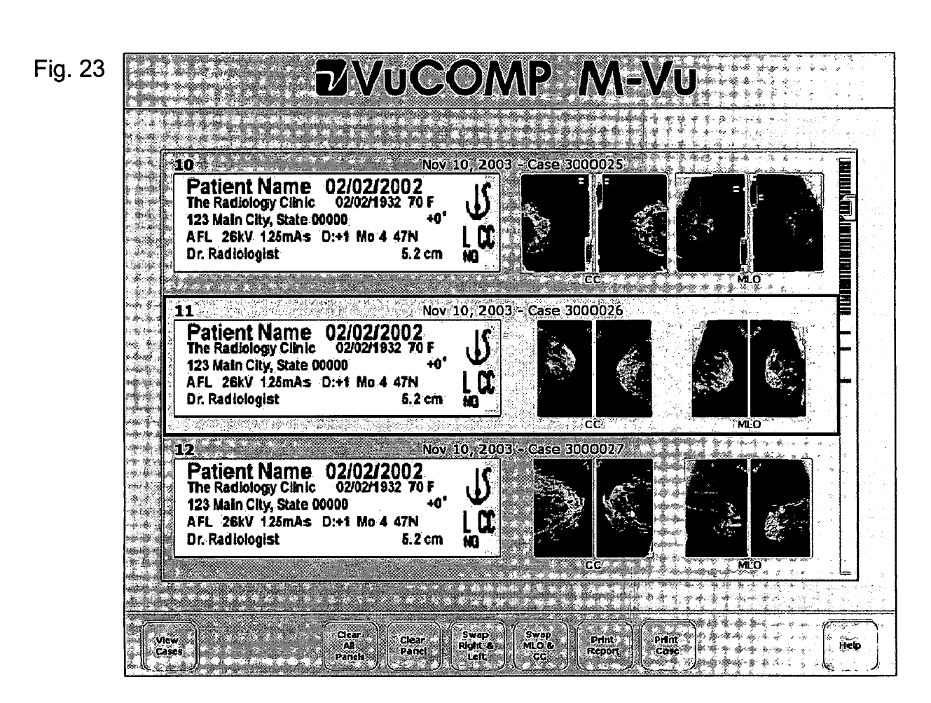

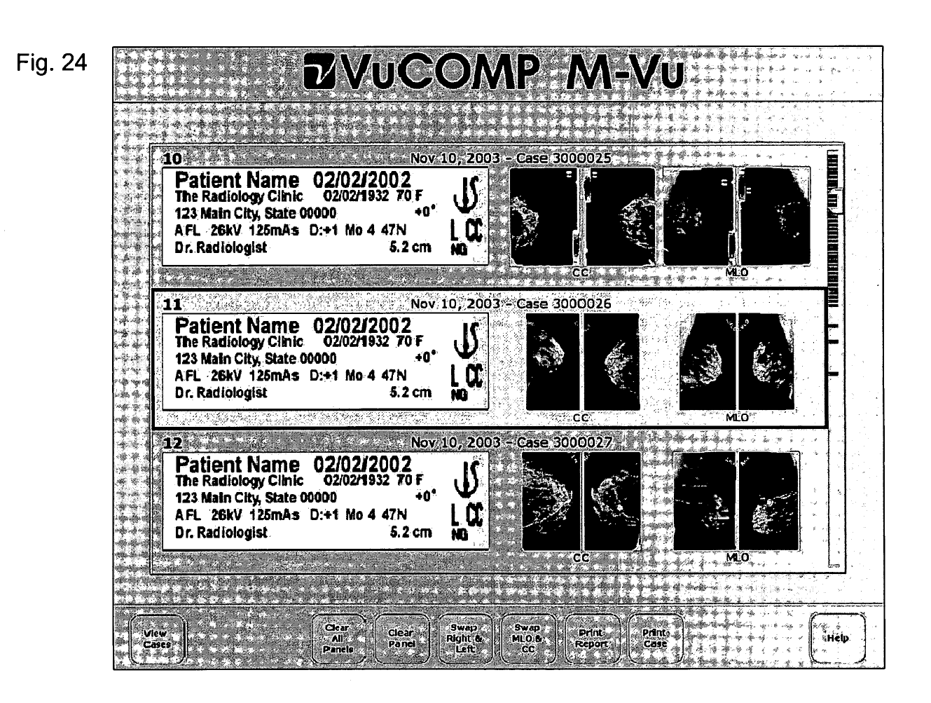

The next two buttons change the film order to correspond with radiologist preferences, and affect all loaded cases. The “Swap MLO & CC” button reverses the current ordering of CC and MLO views in the panel display (and radiologist display), as shown in FIG. 22. The “Swap Left & Right” button reverses the current ordering of left/right breast image display, for both the CC and MLO views, as shown in FIG. 23. By creating both events, a technician can perform both swaps to produce the display order shown in FIG. 24.

The “Print Case” and “Print Report” buttons cause events that send a request to print case information to the CAD server that holds the full case data.

Finally, the “View Cases” button switches the viewing station out of Load Cases mode and into View Cases mode, with the current panel as the displayed panel in View Case mode.

Other control arrangements exist in other embodiments. For instance, instead of the swap display buttons, a single options button can activate a pop-up control panel with various display options. In one embodiment, the pop-up control panel also allows the user to set the number of panels.

Viewing Station View Mode

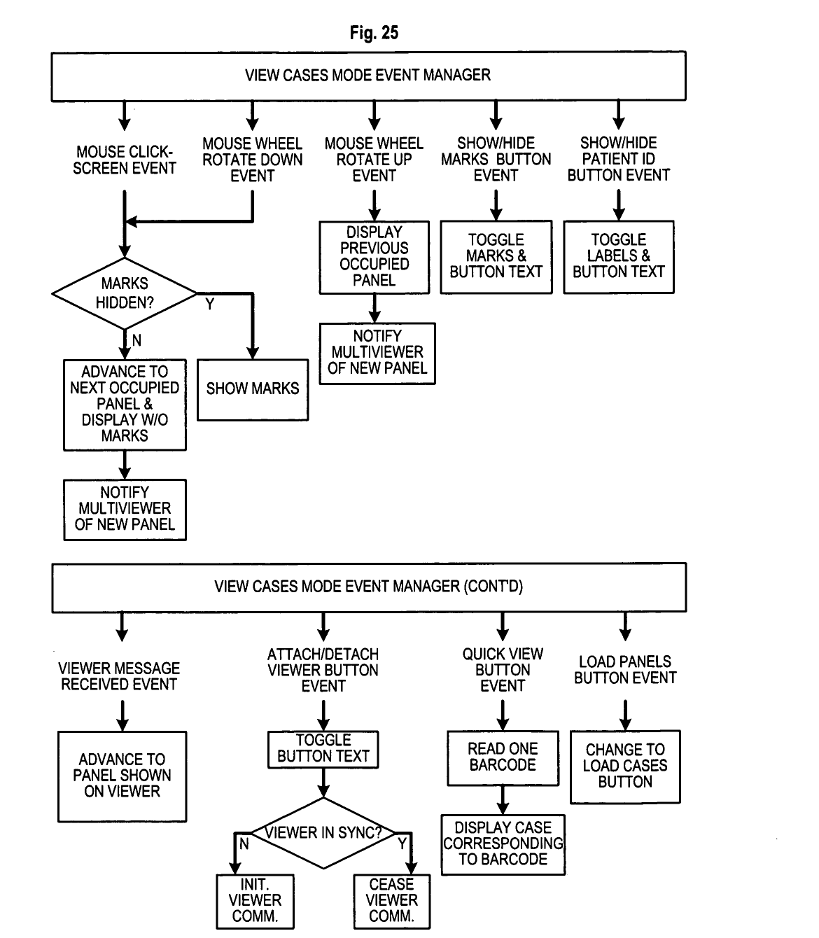

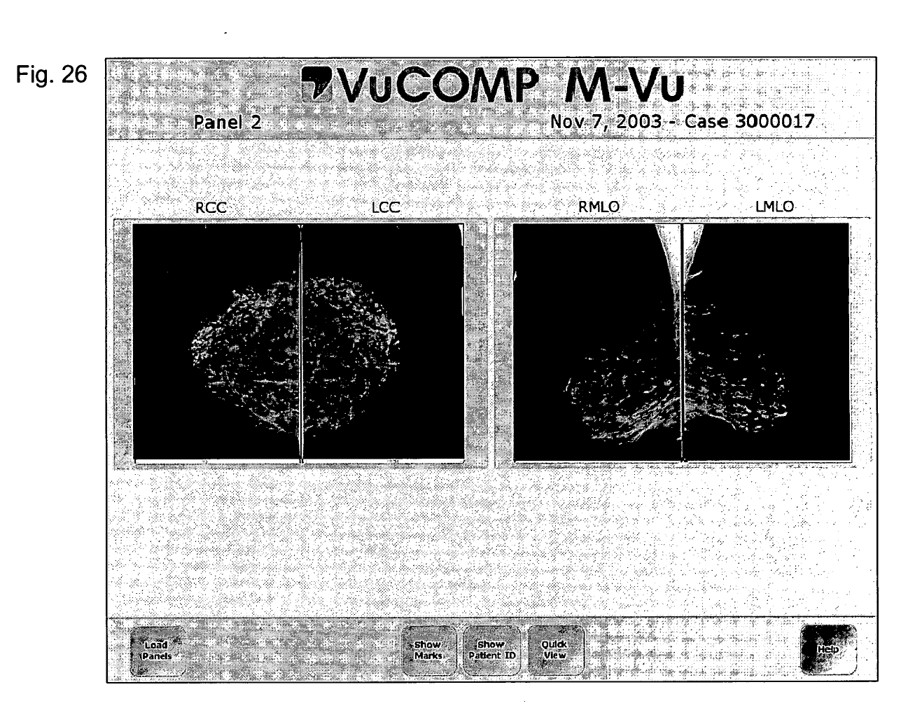

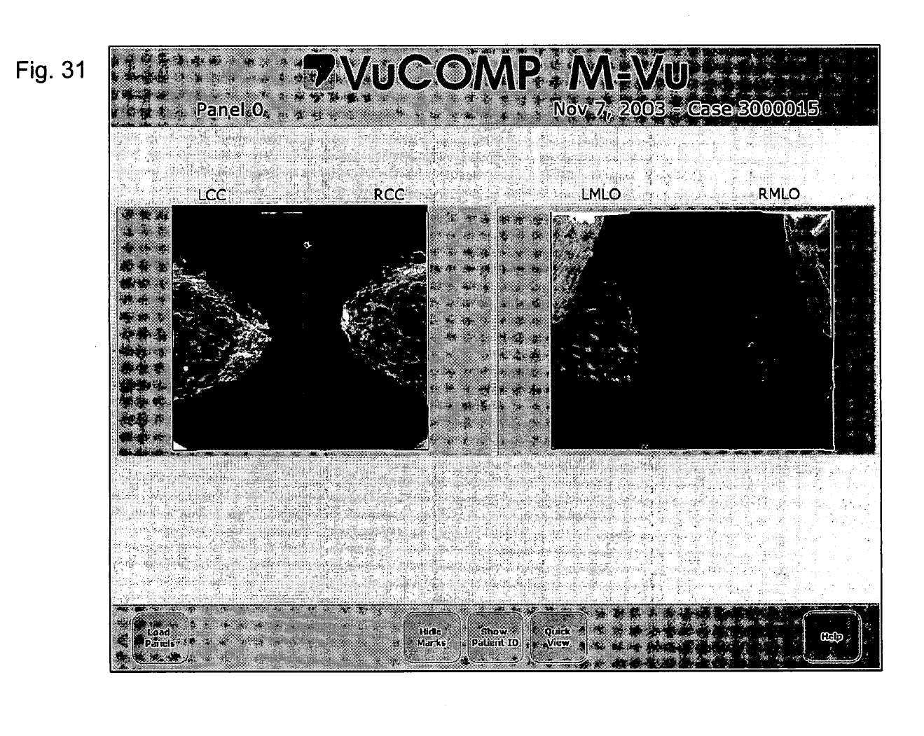

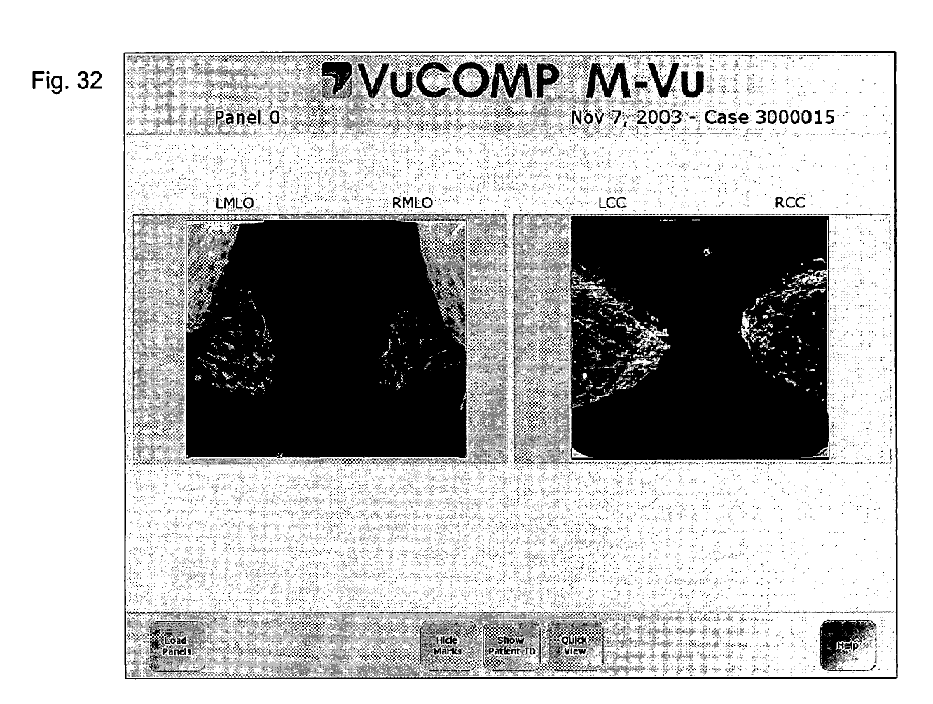

FIG. 25 shows the basic user events that can be initiated by a radiologist during case viewing. FIGS. 26-32 illustrate the appearance of the viewing station display during or after certain of these events, and will be referred to as necessary.

FIG. 26 shows a basic View Cases display screen. Dark colors predominate on the display screen so as not to negatively affect a radiologist's vision in a darkened film reading room. The upper header displays the current panel, date, and case number. The center of the display screen is filled with digitized film images for the current panel, displayed in whatever order was selected in Load Images mode. The bottom of the display contains clickable buttons that the radiologist can manipulate to operate the display.

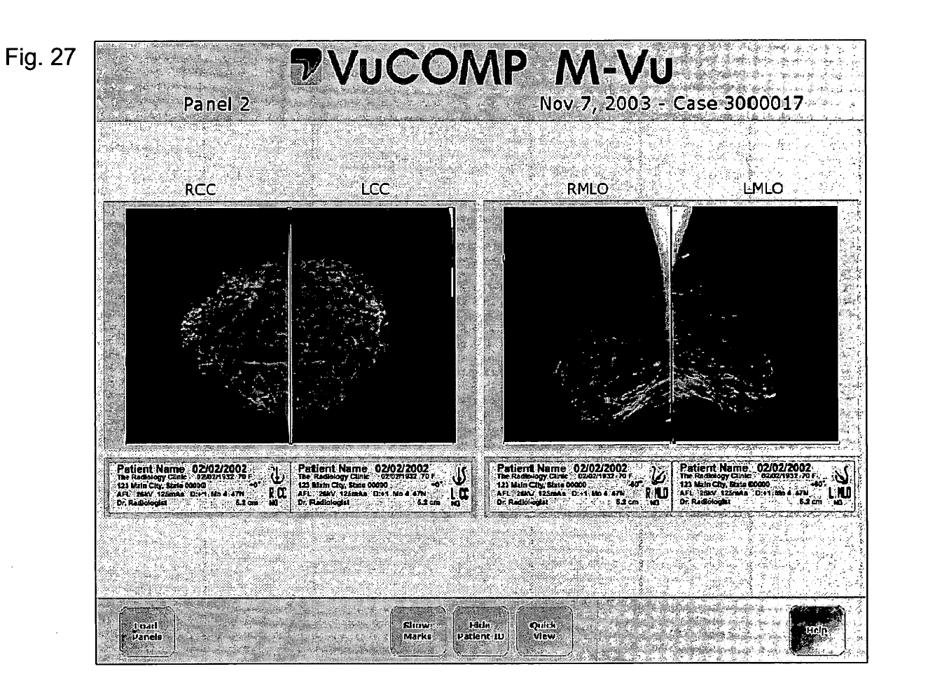

The radiologist can choose to show or hide the labels extracted from the four films, which identify the patient. To toggle, e.g., between the views of FIGS. 26 and 27, the radiologist clicks the show patient ID button (FIG. 26) or the hide patient ID button (FIG. 27), which appear in the same location in the display and change depending on the current label display mode.

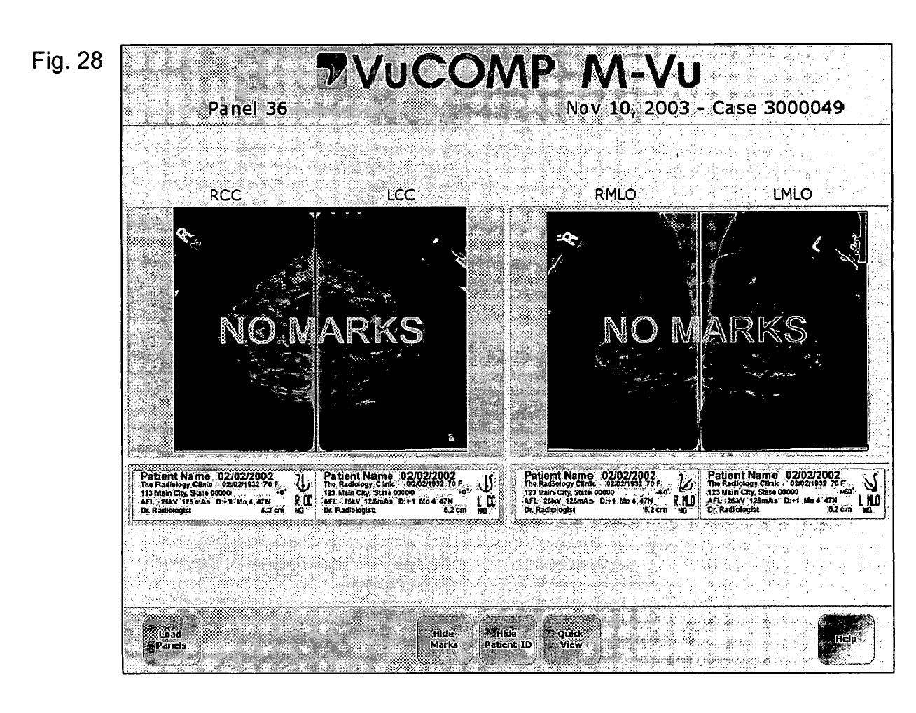

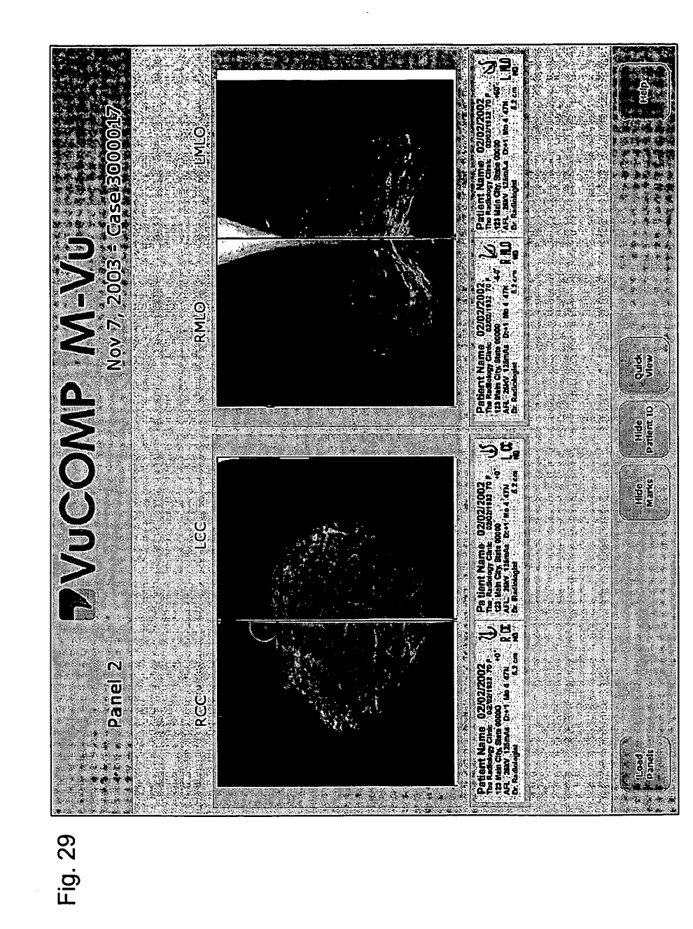

The radiologist navigates through the loaded panels using mouse click and/or mouse wheel events. A mouse click event that is not on one of the clickable buttons or a mouse wheel rotate down event cause the same response. If marks are hidden, like in FIG. 27, the display is changed to one like FIG. 29 to show marks using the same symbology used on the CAD results printouts. Note that if no marks were found, labels “NO MARKS” are prominently displayed (FIG. 28) across the film images in show marks mode, so that the radiologist does not need to search the images for marks that are not there. Similarly, should a CAD processing error occur on an image, labels “ERROR PROCESSING CASE” are prominently displayed on the image.

If marks are already displayed on the current panel, a mouse click or mouse wheel rotate down event advances the display to the next occupied panel and displays the images without marks. A mouse wheel rotate up event advances the display backwards to the previous occupied panel. This ability allows the radiologist to easily navigate through the loaded panels using single clicks without having to aim and click the mouse on a button each time.

Mouse manipulation can also be defined to cause other display behavior. For instance, the viewing station can be set to a mode (not shown) that zooms in on an area of a digitized film image when that area is pointed to and clicked or “boxed” by a radiologist.

The radiologist can also toggle between showing and hiding marks using the “Show Marks” button (FIG. 27) when marks are hidden and the “Hide Marks” button (FIG. 29) when marks are visible to toggle the marks and the button text.

The Quick View button allows a radiologist to quickly navigate to a particular loaded case, or load an unloaded case, using a CAD results printout with a barcode. When the “Quick View” button is selected, the barcode scanner is activated (it is normally deactivated in View Mode to reduce stray light) until a single barcode is passed under the barcode scanner. The viewing station then locates the corresponding panel, or requests the case from the CAD station if it is not loaded, and then places that case on the display.

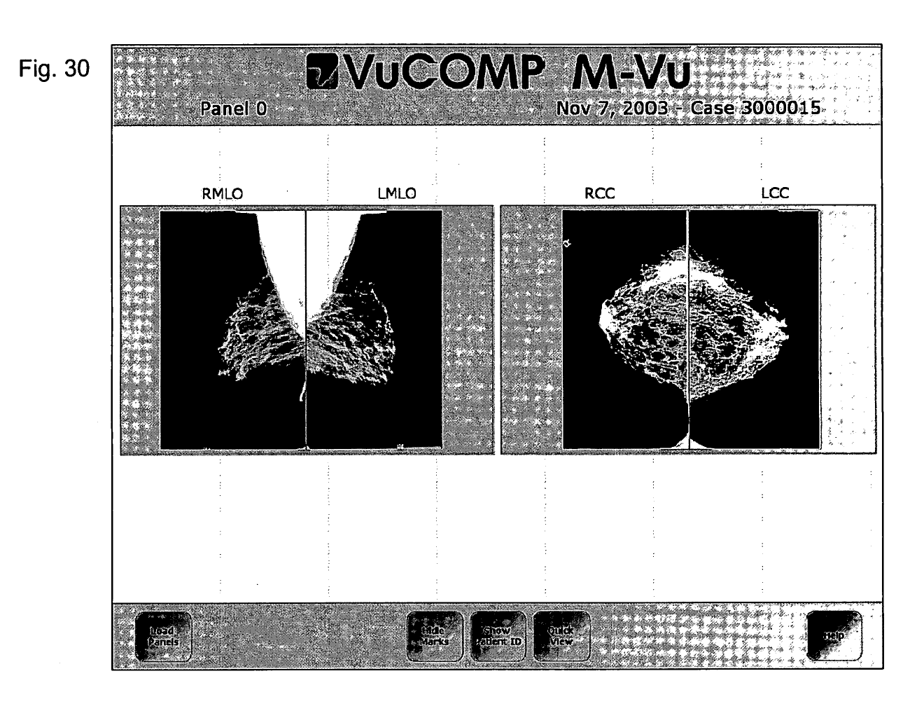

The radiologist can also access the Load Panels functionality using the Load Panels button. Finally, FIGS. 30-32 correspond to FIGS. 22-24, respectively, showing the different film arrangements possible by changing display modes in the Load Panels function.

Other modes of panel navigation are possible. For instance, if the film multi-viewer has a serial or other electronic output indicating when panels are advanced, that output can be connected to the viewing station to step the CAD view at the same time. Another possibility would be to have the CAD viewing station instruct the film multi-viewer to step when the viewing station steps. A separate button (not shown) will appear on the display when the CAD viewing station has an established communication link with a film multi-viewer. When the film multi-viewer and CAD viewing station are not slaved to each other, the button text reads “Attach Viewer.” When the film multi-viewer and CAD viewing station are synchronized, the button text reads “Detach Viewer.”

As shown in FIG. 25, when an operator selects the Attach/Detach Viewer button, an Attach/Detach Viewer button event is generated. This event toggles the button text, and toggles the synchronization state of the system. When the film multi-viewer and CAD viewing station are not synchronized, an initialization sequence will be communicated with the multi-viewer, allowing the CAD viewing station to advance to the current film panel and receive further panel navigation messages from the multi-viewer. When the film multi-viewer and CAD viewing station are synchronized, the CAD viewing station will change state such that it ignores panel navigation messages from the multi-viewer, and will not send panel navigation messages to the multi-viewer.

When the film multi-viewer and CAD viewing station are synchronized, panel navigation messages are communicated between the CAD viewing station embedded computer and a controller in the film multi-viewer. When an operator selects a new panel on the film multi-viewer, the multi-viewer controller sends a notification message to the embedded computer, creating a viewer message received event as shown in FIG. 25. The CAD viewing station responds to this event by advancing to the same panel of CAD images. Also, when an operator navigates to a following or preceding occupied panel loaded on the CAD viewing station, a notification message is sent to the film multi-viewer controller. The controller can then advance the film multi-viewer to display the films corresponding to the currently displayed CAD images.

Although described and shown for the viewing station view mode, synchronization between the CAD viewing station and film multi-viewer can be activated in similar fashion in the load cases mode.

Although some embodiments of representative CAD systems, components, and methods have been described, many other additional or alternative features are possible. For instance, although the CAD station described requires four properly ordered films for each case, alternative embodiments can detect and correct film order/orientation. When labels are extracted by the CAD algorithms, the labels can be cross-checked to automatically verify that they belong to the same patient. Optical character recognition can also be used to retrieve identifying information directly from the film labels. Although the described process is “stickerless,” an alternate embodiment could generate one or more stickers to be applied directly to a film. Preferred embodiments use a laser barcode scanner mounted to the back of a CAD display, but other possibilities exist. Other types of barcode scanners, such as charge-coupled-device scanners, can be used. The scanner itself can be mounted in other embodiments within the display case, mounted to the bottom, front, or side of the display case, or possibly even on some part of the display arm.

The preceding embodiments are exemplary. Although the specification may refer to “an,” “one,” “another,” or “some” embodiment(s) in several locations this does not necessarily mean that each such reference is to the same embodiment(s), or that the feature only applies to a single embodiment.

1. A Computer-Aided Detection (CAD) results viewing system comprising:
a computer system to retrieve CAD results for multiple patients;
an electronic display to display the CAD results to a user; and
a barcode scanner, coupled to the computer system, to read barcodes printed on CAD hardcopy printouts, each hardcopy printout barcode corresponding to CAD results, the computer system responding to a barcode read by the barcode scanner by retrieving CAD results corresponding to the barcode and queuing the retrieved CAD results for display on the electronic display.

2. The CAD results viewing system of claim 1, further comprising an articulated mounting arm coupled to the electronic display at one end, the arm having means at the opposite end for attaching the arm to a film viewer station.

3. The CAD results viewing system of claim 2, wherein the means for attaching the arm attaches the arm to a film viewer station such that the display is positionable over a user work surface on the film viewer station.

4. The CAD results viewing system of claim 3, wherein the barcode scanner is mounted to the display.

5. The CAD results viewing system of claim 4, wherein the barcode scanner is mounted to the backside of the display so as to read barcodes on hardcopy printouts placed under the display.

6. The CAD results viewing system of claim 4, wherein the barcode scanner is mountable to the backside of the display in at least two different lateral positions along the backside of the display.

7. The CAD results viewing system of claim 2, wherein the computer system is mounted with the display on the mounting arm.

8. The CAD results viewing station of claim 1, wherein the barcode scanner is mounted to the display.

9. The CAD results viewing station of claim 1, further comprising a pointing device coupled to the computer system.

10. The CAD results viewing station of claim 1, wherein cooling for the computer system is provided without forced air means.

11. The CAD results viewing station of claim 1, wherein the computer system comprises a solid state nonvolatile memory and a solid state volatile memory, wherein all local storage of computer system software and CAD results data is provided on the solid state memories.

12. A method of displaying CAD results to a user, the method comprising:
machine-reading a case identifier on a CAD hardcopy printout corresponding to a case;
using the machine-read case identifier to queue CAD results for the case; and
electronically displaying the queued CAD results to the user.

13. The method of claim 12, wherein using the machine-read case identifier to queue CAD results comprises querying a remote CAD server with the machine-read case identifier, and accepting the CAD results from the remote CAD server in response to the query.

14. The method of claim 13, wherein multiple CAD hardcopy printouts are machine-read, wherein the CAD results corresponding to the multiple CAD hardcopy printouts are queued for display to the user in the same order that the CAD hardcopy printouts are presented for machine reading.

15. The method of claim 14, further comprising advancing the display of the CAD results to the next queued case by selecting a button on a pointing device.

16. The method of claim 14, further comprising advancing the display of the CAD results in response to a panel navigation message received from a film multi-viewer.

17. The method of claim 12, wherein machine-reading a case identifier comprises sensing the case identifier with a barcode scanner, and wherein electronically displaying the queued CAD results on a monitor mounted with the barcode scanner.

18. The method of claim 17, further comprising mounting the monitor and barcode scanner on an articulated arm that allows the monitor to be positioned relative to a film viewer.

19. A method of integrating a CAD results display system with a film multi-viewer, the method comprising:
mounting a flat panel display on an articulated arm that allows the flat panel display to be positioned in proximity to a film display portion of the film multi-viewer;
mounting a barcode scanner with the flat panel display such that the barcode scanner is capable of reading case identifiers printed on CAD hardcopy printouts;
coupling the flat panel display and the barcode scanner to a computer system; and
when a case identifier is read from a CAD hardcopy printout by the barcode scanner, the computer system queueing CAD results corresponding to the CAD hardcopy printout for display on the flat panel display.

20. The method of claim 19, wherein the articulated arm is mounted to a work surface on the film multi-viewer such that the flat panel display is positionable over the work surface.

21. The method of claim 20, wherein the barcode scanner is mounted such that the barcode scanner is capable of reading case identifiers printed on CAD hardcopy printouts placed on the work surface.

22. The method of claim 19, further comprising mounting the computer system with the flat panel display on the articulated arm.

23. The method of claim 19, further comprising electronically coupling the CAD results display system to the film multi-viewer, providing a navigation tool that allows a user to select a panel of queued CAD results for display on the CAD results display system, and using the electronic coupling to select a panel on the film multi-viewer when a user selects a corresponding panel of CAD results on the CAD results display system.

24. A CAD system comprising:
a self-contained portable CAD cart having hardware to digitize films into CAD cases, perform CAD processing on the CAD cases, print result pages for the CAD cases, and store the CAD cases and results for retrieval by a separate system over an electronic link; and
at least one CAD viewing station having hardware to identify CAD cases from the printed results pages, retrieve the identified CAD cases from the CAD cart over the electronic link, and display the identified CAD cases to a user.

25. A CAD processing system comprising:
a film scanner to digitize films into CAD cases;
a user interface providing overall system control and providing case progress information to an operator;
a printer to provide hardcopy printouts of the CAD cases after CAD processing; and
computer means coupled to the film scanner, user interface, and printer, the computer means having a first central processing unit (CPU) to control the overall system operation and assign CAD processing tasks to other CPUs, the computer means also having at least one second CPU to perform CAD processing tasks at the request of the first CPU and return results of the CAD processing tasks to the first CPU.

26. A self-contained portable CAD cart comprising:
a wheeled lower platform;
an electronic enclosure mounted on the wheeled lower platform, the electronics enclosure including a chassis attachment point for at least one CAD processing computer;
a printer shelf above the electronics enclosure to hold a CAD results printer;
a film scanner shelf above the printer shelf to hold a film scanner; and
a display screen mount attached to the film scanner shelf;

27. The portable CAD cart of claim 26, further comprising shelf struts located toward the rear of the CAD cart, the shelf struts cantilevering the film scanner shelf over the printer shelf.

28. The portable CAD cart of claim 26, including in the electronics enclosure a bottommost chassis attachment point for an uninterruptible power supply (UPS).

29. The portable CAD cart of claim 28, further comprising:
at least one CAD processing computer and a UPS mounted in the electronics enclosure;
a CAD results printer on the printer shelf and coupled to the CAD processing computer;
a film scanner on the film scanner shelf and coupled to the at least one CAD processing computer and the UPS; and
a display screen attached to the display screen mount and coupled to the at least one CAD processing computer and the UPS.

30. A method of operating a CAD system, the method comprising:
using a first CPU to interface with CAD case input and output devices, to assign cases to other CPUs for CAD processing, and store CAD processing results; and
using at least one second CPU to perform CAD processing on CAD cases assigned by the first CPU.

31. A method of operating a CAD system, the method comprising:
detecting that external power to the CAD system has been interrupted;
in response to the detected power interruption, shutting down a film scanner after allowing the film scanner to complete any in-progress film scan;
suspending CAD processing of any in-progress CAD processing task; and
shutting down computer hardware responsible for CAD processing.

32. A method of operating a CAD system, the method comprising:
processing a CAD case comprising at least one medical image;
printing a results page for the CAD case, the results page including a machine-readable code identifying the CAD case, information indicating that the CAD case has been processed, and a printed version of the at least one medical image.

33. The method of claim 32, further comprising:
extracting label data from the at least one medical image; and
printing on the results page the extracted label data with the printed version of the at least one medical image.

34. The method of claim 32, further comprising:
printing on the results page, in color and in registration with the printed version of the at least one medical image, marks corresponding to any suspicious regions located on the at least one medical image by CAD processing.

35. A method of queuing CAD cases for viewing on a viewing station, the method comprising:
displaying a graphical user interface to an operator, the graphical user interface having the appearance of a collection of scrollable panels, each panel associable with a queued CAD case;
accepting user input identifying a CAD case;
retrieving the CAD case and associating the retrieved CAD case with one of the scrollable panels; and
displaying information from the retrieved CAD case in its associated scrollable panel.

36. The method of claim 35, wherein displaying information from the retrieved CAD case in its associated scrollable panel comprises displaying label data extracted from at least one medical image associated with the CAD case, and displaying a digitized version of the medical image.

37. The method of claim 35, the graphical user interface comprising a manipulable scroll tool indicating which portion of the collection of scrollable panels is currently displayed and indicating which panels from the collection of scrollable panels are currently associated with CAD cases.

38. The method of claim 35, further comprising:
maintaining displayed panel synchronization with a film multi-viewer; and
when a CAD case is retrieved in response to user input, associating the CAD case with the scrollable panel corresponding to a current panel selected on the film multi-viewer.

39. A method of displaying CAD results to a user, the method comprising:
queuing multiple CAD cases for sequential display to a user;
responding to a repeated user selection gesture by alternately
when the last response to the user selection gesture was the display of CAD results for the preceding CAD case in the sequence, advancing to the next case in the sequence of multiple CAD cases and displaying digitized versions of medical images for that next case, and
when the last response to the user selection gesture was advancing to the next case in the sequence and displaying digitized version of medical images for that next case, displaying CAD results for the currently displayed CAD case.

40. The method of claim 39, wherein the user selection gesture is a button click on a pointing device.
